(19) United States
(12) Patent Application Publication
(10) Pub. No.: US 2013/0309365 A1
(43) Pub. Date: Nov. 21, 2013

(54) Fortune Cookie with Edible Fortune

(71) Applicant: Yu Zheng, Walnut, CA (US)

(72) Inventor: Yu Zheng, Walnut, CA (US)

(73) Assignee: PATENT CATEGORY CORP., Walnut, CA (US)

(21) Appl. No.: 13/472,102

(22) Filed: May 15, 2012

(51) Int. Cl. A21D 13/00

(52) U.S. Cl. 426/87

(57) ABSTRACT

A cookie has a cookie batter that has been folded into the shape of a fortune cookie, with a piece of edible paper housed inside the folded cookie, the edible paper having a fortune written thereon in a non-toxic edible ink.

### BACKGROUND OF THE INVENTION

1. Field of the Invention

The present invention relates to fortune cookies, and in particular, to a fortune cookie that has an edible fortune.

2. Description of the Prior Art

Fortune cookies are very popular, both at Chinese restaurants and as snacks, Each fortune cookie typically has a fortune enclosed inside the cookie. The fortune is usually written on a rectangular sheet of paper. The fortune provides the novelty in that the consumer will be entertained by reading his/her fortune.

There are several drawbacks associated with conventional fortune cookies. First, because the fortune is written on a piece of paper, the consumer needs to crack open the cookie and remove the paper before eating the cookie. There are times when a consumer merely wants to eat the cookie without reading the fortune. Second, the paper often gets discarded, creating unwanted trash.

Thus, there remains a need for fortune cookies that overcome the drawbacks described above.

### SUMMARY OF THE DISCLOSURE

In order to accomplish the objects of the present invention, there is provided a cookie having a cookie batter that has been folded into the shape of a fortune cookie, with a piece of edible paper housed inside the folded cookie, the edible paper having a fortune written thereon in a non-toxic edible ink.

### BRIEF DESCRIPTION OF THE DRAWINGS

FIGS. 1-7 illustrate the steps for making a fortune cookie according to one embodiment of the present invention.

FIG. 8 illustrates the provision of other edible fillings inside a fortune cookie according to the present invention.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

The present invention provides a fortune cookie where the fortune is written on a piece of edible paper. As a result, the consumer can eat the cookie without breaking it apart to remove the paper. In addition, the paper can be eaten with the cookie after the fortune has been read.

FIGS. 1-7 illustrate a method of making a fortune cookie according to the present invention.

Referring to FIG. 1, a piece of edible paper 20 is provided, and non-toxic ink is used to imprint the fortune 22 on to the paper 20. The edible paper 20 is preferably cut to the size and rectangular shape of a conventional fortune cookie. In one embodiment, the paper 20 can be three inches long, and half an inch wide. The edible paper 20 can be provided in the form of any of the edible papers that are currently available in the market, and non-limiting examples include edible paper made out of potatoes, sweet potatoes, rice, icing, and sugar. Examples of non-toxic ink include ink that is made out of food coloring such as soy-based ink or powder that is soluble in water.

As used herein, the term “edible” means paper and ink that can be consumed without harsh effects on a normal human being's digestive system. Usually, the edible paper has no flavor and very little texture. The paper is firm enough to be printed on in a standard printer.

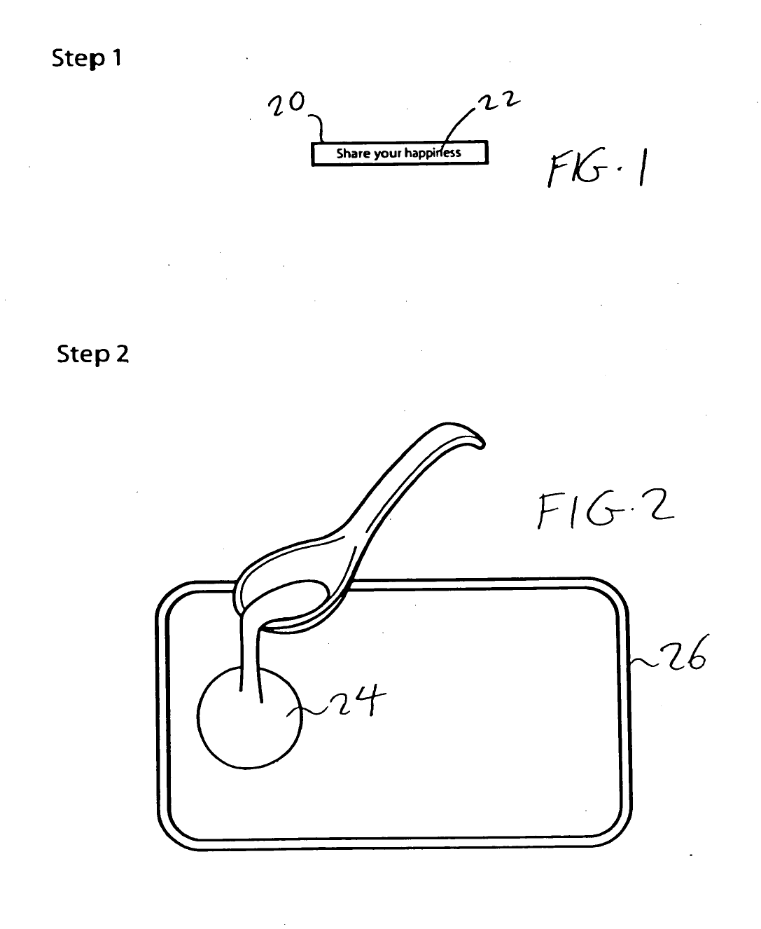

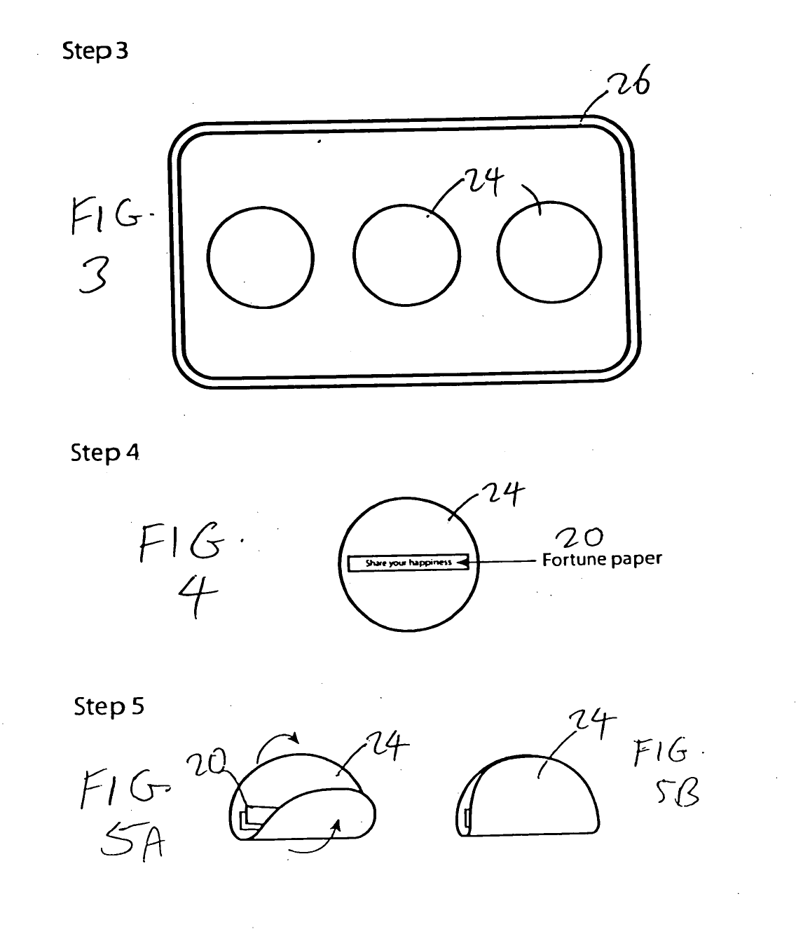

Next, the cookie itself is made. Referring to FIG. 2, a pre-made cookie batter 24 is poured on to a pan 26 in a circular shape having about a diameter of about four inches. In FIG. 3, the pan 26 (with the circular cookie batters 24) is baked until the outer half of the batters 24 turns into a golden brown color, but to a point where the batters 24 are still soft. Next, in FIG. 4, the edible paper 20 is placed in the middle of the circular batter 24.

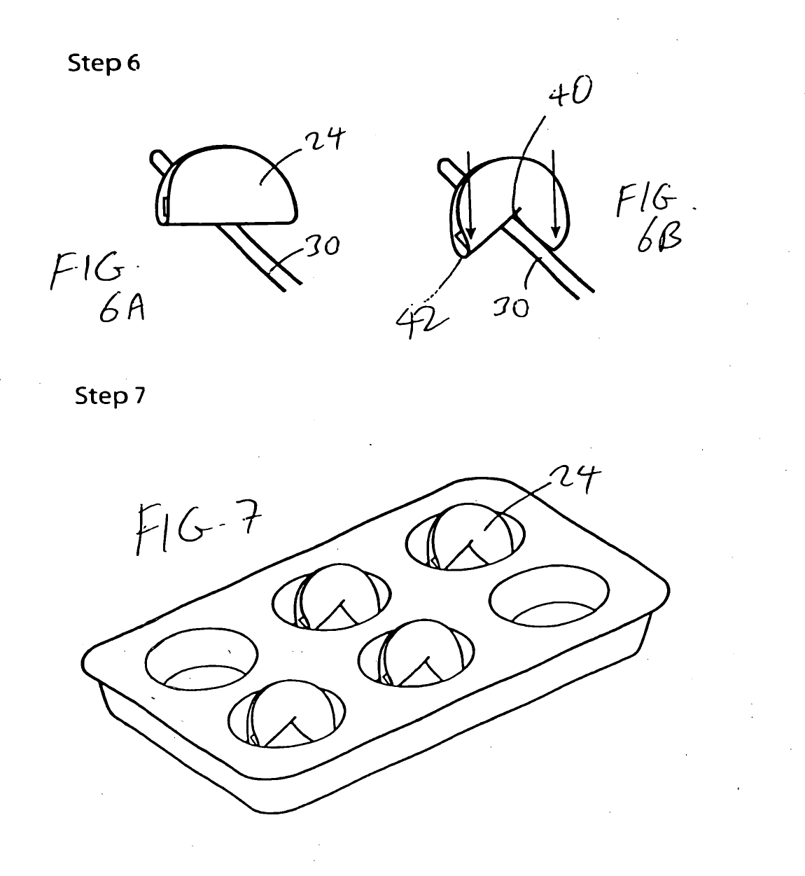

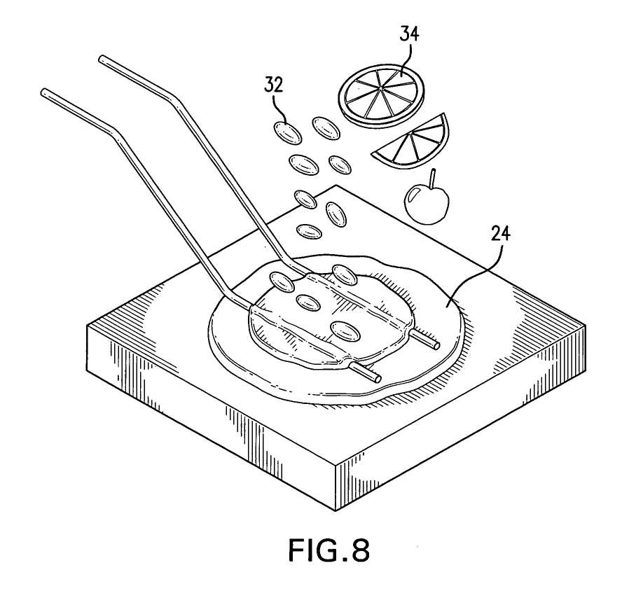

Next, the cookie batter 24 is folded in half, as shown in FIGS. 5A and 5B, and then both edges of the folded cookie batter 24 are pulled gently downward over a round-shaped rim or bar 30, as shown in FIGS. 6A and 6B. This results in the cookie having a crease 40, with two winged edges 42 on either side. Finally, as shown in FIG. 7, the finished cookies 24 are placed in appropriate containers to keep them fresh until they are ready to be packaged.

The present invention is not limited to providing edible paper 20 inside a fortune cookie. It is also possible to include candy 32 or fruit items 34 in the step shown in FIG. 4, thereby providing a variety of different fortune cookies having different fillings. These fillings can be added in lieu of the edible paper 20, or in addition to the edible paper 20. The nature of these fillings can be varied, and even kept secret, much like a fortune, so that the consumer has no idea what filling might be found in any given fortune cookie.

While the description above refers to particular embodiments of the present invention, it will be understood that many modifications may be made without departing from the spirit thereof. The accompanying claims are intended to cover such modifications as would fall within the true scope and spirit of the present invention.

What is claimed is:

1. A cookie, having a cookie batter that has been folded into the shape of a fortune cookie, with a piece of edible paper housed inside the folded cookie, the edible paper having a fortune written thereon in a non-toxic edible ink.

2. The cookie of claim 1, further including candy housed inside the folded cookie.

3. The cookie of claim 1, further including a piece of fruit housed inside the folded cookie.

4. The cookie of claim 1, wherein the edible paper is made out of potatoes, sweet potatoes, rice, icing, or sugar.

5. The cookie of claim , wherein the non-toxic ink is made out of soy-based ink.
